(19) United States
(12) Patent Application Publication
(10) Pub. No.: US 2026/0110386 A1
(43) Pub. Date: Apr. 23, 2026

(54) DEVICES AND METHODS FOR REPAIRING PIPES

(71) Applicant: Mueller International, LLC, Atlanta, GA (US)

(72) Inventors: David Latimore Hughes, JR., Signal Mountain, TN (US); Jason White Bradley, Soddy-Daisy, TN (US)

(21) Appl. No.: 18/918,453

(22) Filed: Oct. 17, 2024

(51) Int. Cl. F16L 55/134

(52) U.S. Cl. CPC F16L 55/134

(57) ABSTRACT

Example aspects of a linestopping plug assembly and method for securing fluid flow fluid within a pipeline are disclosed. The linestopping plug assembly can comprise a body portion having a front body portion and a rear body portion; and an inflatable bag seal that is affixed to the body portion and comprises a cylindrical wide wall, wherein the inflatable bag seal is inflatable between a first deflated state in which a flow volume is defined between the cylindrical side wall and an inner surface of the pipe, and a second inflated state in which the cylindrical side wall is in contact with the inner surface of the pipe, thereby preventing fluid flow.

### TECHNICAL FIELD

This disclosure relates to the field of pipe repair. More specifically, this disclosure relates to a linestopping plug system for securing fluid flow withing a pipe to facilitate leak detection and repair of the pipe.

### BACKGROUND

Piping systems, including municipal water systems, can develop breaks in pipe walls that can cause leaking. Examples of breaks in a pipe wall can include radial cracks, longitudinal cracks, point cracks, etc. Leaking also commonly occurs at joints in the piping system. Locating and repairing a leak in a pipe wall often requires the piping system to be shut off, which can be inconvenient for customers and costly for providers. Furthermore, de-pressurizing the can increase of the risk of undesirable foreign objects (e.g., bacteria, dirt, etc.) entering the pipeline at the location of the leak or in other parts of the piping system.

Additionally, locating the break site and repairing the break can necessitate grandiose construction, including the digging up of streets, sidewalks, and the like, which can be costly and time-consuming.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts off the disclosure as an introduction to the following complete and extensive detailed description.

Disclosed is a linestopping plug assembly for securing flow of a fluid within a pipe, comprising a body portion having a front body portion and a rear body portion; and an inflatable bag seal that is affixed to the body portion and comprises a cylindrical side wall, wherein the inflatable bag seal is inflatable between a first deflated state in which a flow volume is defined between the cylindrical side wall of the inflatable bag seal and an inner surface of the pipe, and a second inflated state in which the cylindrical side wall is in contact with the inner surface of the pipe about a full circumference of the cylindrical side wall of the inflatable bag seal.

Also disclosed is a pipe repair system for repairing a leak in a pipe, comprising at least one linestopping plug assembly comprising a body portion having a front body portion and a rear body portion; and an inflatable bag seal that is affixed to the body portion and comprises a cylindrical side wall, wherein the inflatable bag seal is inflatable between a first deflated state in which a flow volume is defined between the cylindrical side wall of the inflatable bag seal and an inner surface of the pipe, and a second inflated state in which the cylindrical side wall is in contact with the inner surface of the pipe about a full circumference of the cylindrical side wall of the inflatable bag seal; and a pipe repair device comprising a body; a sensor attached to the body for detecting the leak in the pipe; a transport mechanism attached to the body for transporting the pipe prepare device along the pipe; and a repair mechanism comprising a repair material for repairing the leak.

A method for repairing a pipeline is also disclosed, comprising the steps of providing a pipe repair system comprising a pipe repair device and at least one linestopping plug assembly having an inflatable bag seal; inserting the pipe repair system into the pipeline; detecting a leak at a leak region of the pipeline; preventing fluid flow within the pipeline by inflating the inflatable bag seal; and repairing the leak.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and, together with the description, explain various principles of the disclosure. The drawings are not necessarily drawn to scale.

Corresponding features and components throughout the figures may be designated by matching reference characters for the sake of consistency and clarity.

FIG. 1 is a side plan view of a leak detection and pipe repair system including a linestopping plug system, in accordance with one aspect of the present disclosure.

FIGS. 2A and 2B are rear perspective views of a linestopping plug assembly shown in FIG. 1 with the gripper plates in the rearward stowed position and in the forward engaged position, respectively.

FIG. 3 is a side plan view of the linestopping plug assembly shown in FIG. 1 with the top gripper plate in the forward engaged position and the bottom gripper plate in the rearward stowed position.

FIG. 4 is a perspective cross-sectional view of the linestopping plug assembly shown in FIG. 3 taken along line 4-4.

FIG. 5 is a perspective view of a linestopping plug assembly in accordance with another aspect of the present disclosure.

FIG. 6 is a partial perspective view of an annular grip ring of the linestopping plug assembly shown in FIG. 5.

FIG. 7 is a cross-sectional side view of the linestopping plug assembly shown in FIG. 5, taken along line 7-7.

FIG. 8 is a schematic view of a pipe repair device of the leak repair and pipe repair system shown in FIG. 1, in accordance with one aspect of the present disclosure.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element”can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed in the present application is a leak detection and pipe repair device and associated methods, systems, devices, and various apparatus. Example aspects of the leak detection and pipe repair device can comprise a locomotion subsystem, a leak detection subsystem, and a pipe repair subsystem. It would be understood by one of skill in the art that the disclosed leak detection and pipe repair device is described in but a few exemplary aspects among many. No particular terminology or description should be considered limiting on the disclosure or the scope of any claims issuing therefrom.

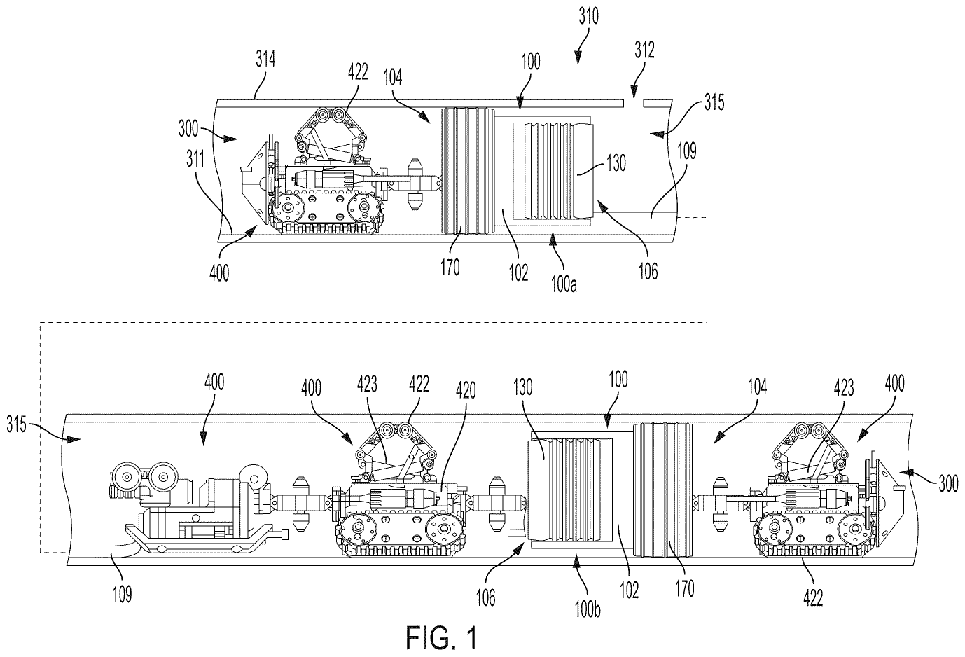

FIG. 1 illustrates a first aspect of a leak detection and pipe repair system 300 (hereinafter, the “pipe repair system 300”), including a pair of linestopping plug assemblies 100, according to the present disclosure. Example aspects of the pipe repair system 300 can include one or more leak detection and pipe repair devices 400 (hereinafter, “pipe repair device 400”) that can drive through a pressurized pipeline 310, detect a leak 312 in a pipe 314 of the pipeline 310, and repair the damage to the pipe 314 at the location of the leak 312. As shown in FIG. 1, the pipe repair system 300 can also include one or more linestopping plug assemblies 100 in accordance with an aspect of the present disclosure. Linestopping plug assemblies 100 can facilitate leak detection and pipe repair operations by securing fluid flow through a given section of the pipe 310 being repaired. For example, the pair of linestopping plug assemblies 100 can be used to create a dry volume 315 therebetween as a controlled volume workspace in the pipeline 310, as described in further detail below.

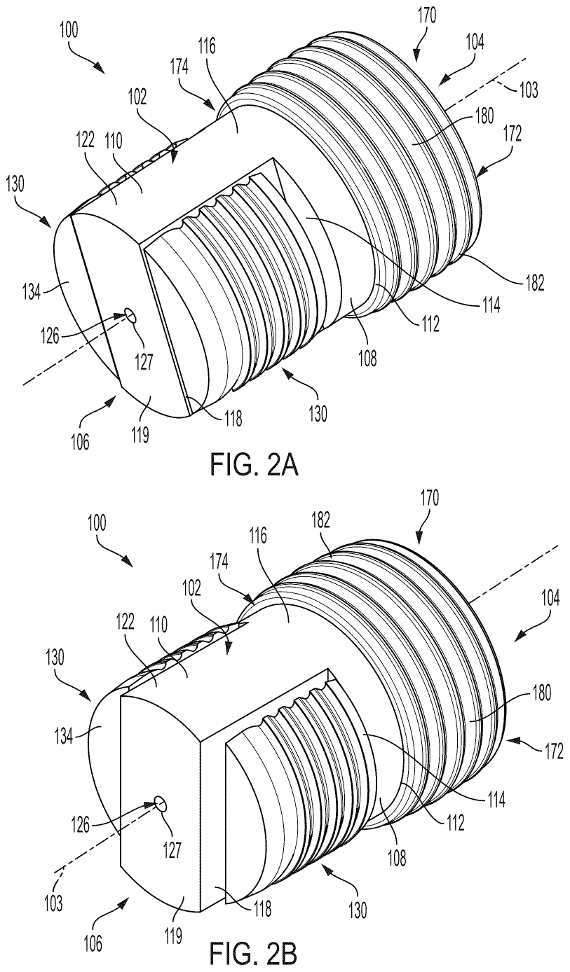

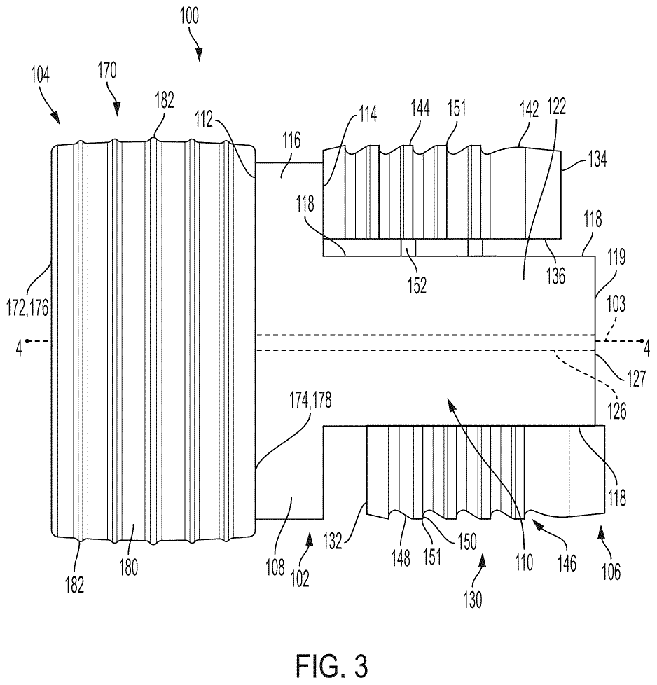

Referring now to FIGS. 2A, 2B, and 3, a linestopping plug 100 in accordance with the first aspect of the present disclosure is shown. Example aspects of the linestopping plug 100 can include a body portion 102, a pair of gripper plates 130 pivotably attached to a rear portion 110 of the body portion 102, and an inflatable bag seal 170 attached to the front end 104 of the body portion 102. The body portion 102 can include a substantially cylindrical front body portion 108 defined by planar front wall 112, a planar rear wall 114, and a cylindrical outer wall 116 extending therebetween. The rear body portion 110 can extend rearwardly from the rear wall 114 of the front body portion 108 and can include a pair of parallel side walls 118 and a planar rear wall 119 that is transverse to a longitudinal center axis 103 of the linestopping plug 100. A pair of semi-cylindrical outer walls 122 can extend between corresponding side edges of the parallel side walls 118 of the rear body portion 110, effectively forming axial extensions of the cylindrical outer wall 116 of the front body portion 108. The body portion 102 may be formed, optionally, from an NSF/ANSI 61 certified material that is approved as safe for use in drinking-water applications, such as, for example, stainless steel. In other aspects, the body portion 102 can be formed from another suitable material, such as, for example, aluminum, other metals, plastic, etc.

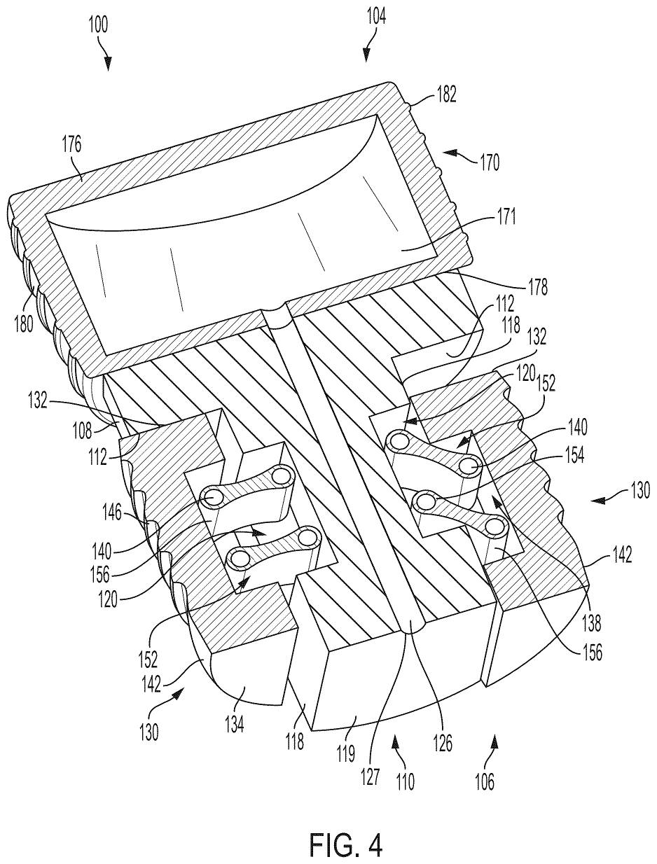

Referring additionally to FIG. 4, each side wall 118 of the rear body portion 110 can define a substantially rectangular recess 120. Each recess 120 of the rear body portion 110 can be configured to pivotably receive the proximal ends 154 of a pair of elongated linkages 152 therein. Each pair of linkages 152 can be configured to pivotably attach a gripper plate 130 to the corresponding side wall 118 of the rear body portion 110.

As best seen in FIGS. 3 and 4, each gripper plate 130 can include a substantially planar inner wall 136 that can be configured to abut one corresponding planar side wall 118 of the rear body portion 110. The inner wall 136 of each gripper plate 130 can define a rectangular recess 138. Each recess 138 can be configured to pivotably receive distal ends 156 of the pair of linkages 152 that can be pivotably secured in the recess 120 of the corresponding side wall 118 of the rear body portion 110. As best seen in FIG. 4, each linkage 152 can include a proximal end 154 that can be pivotably mounted in the recess 120 of the corresponding side wall 118 of the rear body portion 110 by a mounting axle 140. Similarly, the distal end 156 of each linkage 152 can be pivotably mounted in the recess 138 of the corresponding gripper plate 130 by a mounting axle 140. The linkages 152 and recesses 120, 138 can be configured so that each gripper plate 130 can be pivotable between a first rearward position in which the inner wall 136 of the gripper plate 130 can abut the corresponding side wall 118 of the rear body portion 110, and a second forward position in which a planar front wall 132 of the gripper plate 130 can abut the corresponding planar rear wall 114 of the front body portion 108.

One or more actuators (not shown) can be utilized to move the gripper plates 130 between the first rearward position and the second forward position, as needed. In various aspects of the linestopping plug assembly 100, the actuators can be electrically, pneumatically, or hydraulically operated. Note, the forwardmost position of the gripper plate 130 with respect to the body portion 102 can act as an absolute stop for forward motion of the gripper plate 130 relative to the body portion 102. As shown, each gripper plate 130 can also include a substantially planar rear wall 134 that can be parallel to the corresponding front wall 132. In various aspects, the rear wall 134 need not be parallel to the front wall 132. Note, in alternate aspects, the gripper plates 130 need not be pivotably connected to the rear body portion 110 as the actuators can move them outwardly from the body portion transversely to the longitudinal center axis 103.

Still referring to FIGS. 3 and 4, each gripper plate 130 can include a semi-cylindrical outer wall 142 that can extend axially between the outermost edges of the front wall 132 and the rear wall 134 of the corresponding gripper plate 130. The outer wall 142 of each gripper plate 130 can include a plurality of semi-annular ribs 144 that can extend across the width of the outer wall 142. As best seen in FIG. 3, each rib 144 can be defined by an elongated gripper tooth 146 including a front wall 148 and rear wall 150 that can meet at an apex 151 of the tooth 146. The profile of each elongated gripper tooth 146 can slope rearwardly toward the rear end 106 of the linestopping plug 100. As such, the apex 151 of each gripper tooth 146 can be configured to engage an inner surface 311 of the pipe 314 (FIG. 1) in which the linestopping plug 100 can be disposed when the linestopping plug 100 can be moved rearwardly within the pipe 314. The gripper plates 130 can be self-locking after the gripper plates 130 engage the inner surface 311 of the corresponding pipe 314. Specifically, exerting rearward force on a front end 104 of the linestopping plug assembly 100, such as due to fluid pressure from upstream fluid in the pipeline 310, can cause the gripper plates 130 to exert even greater pressure on the inner surface 311 of the pipe 314 due to the pivoting motion of the gripper plates 130 about the mounting axles 140 on proximal ends 154 of the corresponding linkages 152.

An inflatable bag seal 170 can be disposed at the front end 104 of the linestopping plug 100. As shown, a front end 172 of the bag seal 170 can be defined by a planar front wall 176 and a rear end 174 of the bag seal 170 can be defined by a planar rear wall 178 that can be secured adjacent the front wall 112 of the front body portion 108. A cylindrical side wall 180 can extend from an outer perimeter of the front wall 176 to an outer perimeter of the rear wall 178. The side wall 180 of the bag seal 170 can extend radially outwardly beyond the cylindrical outer wall 116 of the front body portion 108 of the linestopping plug 100. As shown, a plurality of annular ribs 182 can extend radially outwardly from an outer surface of the side wall 180 of the bag seal 170. The plurality of annular ribs 182 can be configured to sealingly engage the inner surface of the corresponding pipe 314 in which the linestopping plug 100 may be disposed. The bag seal 170 can be formed from a fiber-reinforced elastic material such as, but not limited to, rubber. Other similar materials can be used in other aspects according to the present disclosure.

The bag seal 170 can define an interior cavity 171 that can be in fluid communication with a longitudinal bore 126 that can extend the entire length of the body portion 102 of the linestopping plug 100. As such, the longitudinal bore 126 can provide a pathway by which the bag seal 170 can be alternately inflated and deflated, as necessary, pneumatically and/or hydraulically. A rear aperture 127 of the longitudinal bore 126 can be defined in the rear wall 119 of the body portion 102 and can act as an attachment point for the pipe repair device 400 so that the pipe repair device 400 can move the linestopping plug assembly 100 within the pipeline 310. The rear aperture 127 can also act as an attachment point for an external hydraulic/pneumatic pressure source for inflating the bag seal by way of a hose, tether, etc., from a first deflated state to a second inflated state.

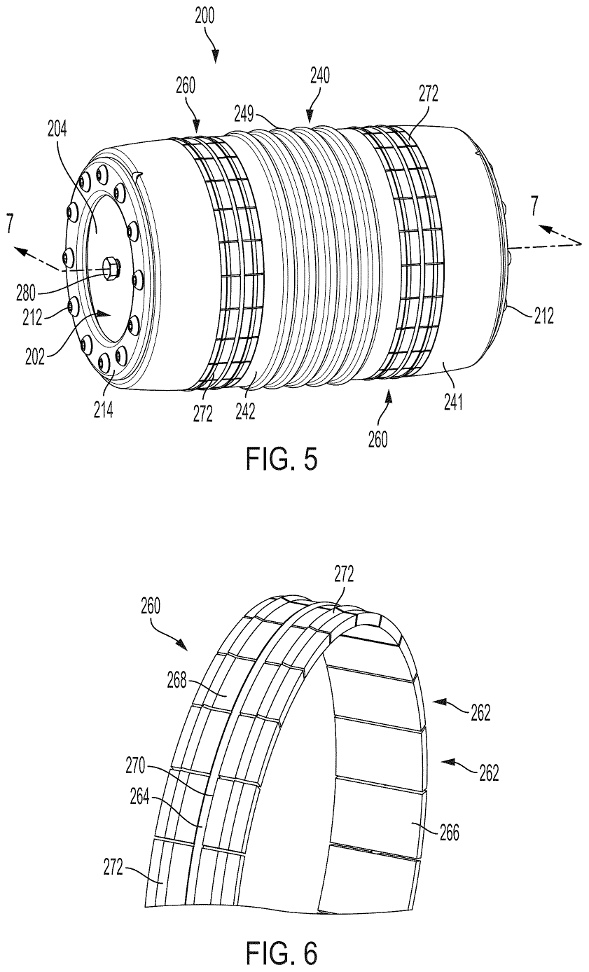

Referring now to FIGS. 5, 6, and 7, a linestopping plug 200 in accordance with another aspect of the present disclosure is shown. Example aspects of the linestopping plug 200 can include a body portion 202 and a bag seal 240 affixed thereto. The body portion 202 can include a front wall 204, a rear wall 206, and a cylindrical outer wall 208 extending therebetween. The front wall 204 and the rear wall 206 can be planar and can be transverse to a longitudinal center axis 201 of the body portion 202. The body portion 202 may be formed, optionally, from an NSF/ANSI 61 certified material that is approved as safe for use in drinking-water applications, such as, for example, stainless steel. In other aspects, the body portion 202 can be formed from another suitable material, such as, for example, aluminum, other metals, plastic, etc.

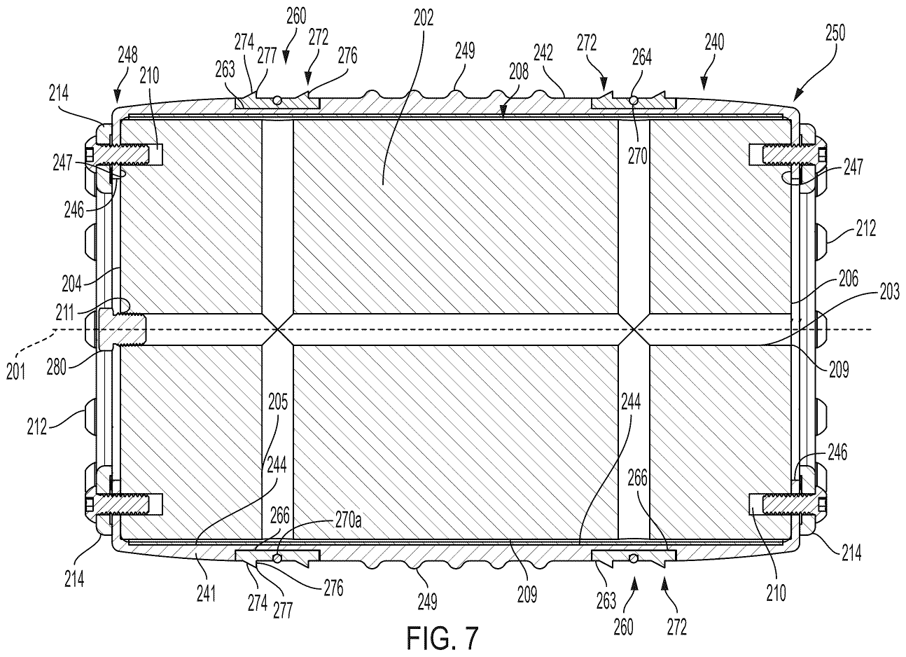

As best seen in FIG. 7, the body portion 202 can include a longitudinal throughbore 203 that can extend from the front wall 204 to the rear wall 206 thereof and can lie along the longitudinal center axis 201 of the body portion 202. A plurality of transverse throughbores 205 can extend through the body portion 202 and can intersect the longitudinal throughbore 203 so that the bores 203, 205 can be in fluid communication. A rear aperture 209 of the longitudinal bore 203 can be defined in the rear wall 206 of the body portion 202 and can act as an attachment point for the pipe repair device 400 so that the pipe repair device 400 can move the linestopping plug assembly 200 within the pipeline 310. The rear aperture 209 can also act as the attachment point for an external hydraulic/pneumatic pressure source for inflating the bag seal 240 by way of a hose, tether, etc. Similarly, a front aperture 211 of the longitudinal bore can be defined in the front wall 204 of the body portion 202 and can act as an attachment point for the pipe repair device 400 and/or an attachment point for an external hydraulic/pneumatic pressure source for inflating the bag seal 240 by way of a hose, tether, etc., from a first deflated state to a second inflated state. As shown, a threaded plug 280 can be disposed in the front aperture 211 to close that end of the throughbore 203.

As shown in FIG. 7, the inflatable bag seal 240 can include a cylindrical side wall 241 that can be disposed adjacent the outer surface 209 of the cylindrical outer wall 208 of the body portion 202 over the entire length of the body portion 202. An annular flange 246 can extend radially inwardly from both the front edge 248 and the rear edge 250 of the cylindrical side wall 241 of the bag seal 240. Each annular flange 246 can include an inner surface that can abut a periphery of the corresponding front wall 204 or rear wall 206 of the body portion 202. As well, both annular flanges 246 can be secured to the corresponding front wall 204 and rear wall 206 by an annular mounting ring 214. Each annular mounting ring 214 can be affixed to the corresponding front wall 204 and rear wall 206 by a plurality of threaded fasteners 212. The mounting rings 214 can secure the annular flanges 246 to the front wall 204 and rear wall 206 in a leak-tight configuration to allow for pneumatically and/or hydraulically inflating the bag seal 240, as discussed below. The bag seal 240 can be preferably formed from a fiber-reinforced elastic material such as, but not limited to, rubber. Other similar materials may be used in other aspects according to the present disclosure.

One aspect of the inflatable bag seal 240 can include a plurality of annular ribs 249 that can extend radially outwardly from the outer surface 242 of the cylindrical side wall 241. In the aspect shown, the plurality of annular ribs 249 can be disposed between annular grip rings 260. The plurality of annular ribs 249 can be configured to sealingly engage the inner surface 311 of a corresponding pipe 314 in which the linestopping plug 200 can be disposed. The bag seal 240 can define an interior volume with the outer wall 208 of the body portion 202, the interior volume being in fluid communication with the longitudinal throughbore 203 and the transverse throughbores 205. As such, the bag seal 240 can be alternately inflated and deflated, as necessary, by way of the longitudinal throughbore 203 and the transverse throughbores 205.

The linestopping plug 200 can include at least one annular grip ring 260 that can be disposed circumferentially about the outer surface 242 of the cylindrical side wall 241 of the bag seal 240. In the aspect shown, front and rear annular grip rings 260 can be provided. As best seen in FIG. 6, each annular grip ring 260 can comprise a plurality of grip pads 262 that can be connected by an elastic cord 264 to allow for expansion radially outwardly as the bag seal 240 inflates. In the aspect shown, each grip pad 262 can include a pair of tooth portions 272 and a groove portion 270 disposed therebetween. Each tooth portion 272 can include a front wall 274 and a rear wall 276 that can meet at a tooth apex 277. The rear wall 276 of each tooth segment 272 can be substantially transverse with regard to the longitudinal center axis 201 of the linestopping plug 200. As such, each tooth segment 272 can actively engage a corresponding portion of the inner surface of a wall of the pipe 314 as the linestopping plug 200 can be urged rearwardly with respect to the corresponding pipe 314, as may occur due to upstream fluid pressure.

Each grip pad 262 can be configured to be slidably received in a corresponding annular groove 266 that can be formed in the outer surface 242 of the cylindrical side wall 241 of the bag seal 240. With the full complement of grip pads 262 disposed in the corresponding annular groove 266, the plurality of groove portions 270 can form an annular groove 270a that can be configured to receive the elastic cord 264 therein. Each grip pad 262 can be configured to move independently of the other grip pads 262 as the elastic cord 264 can expand and contract, such as when the bag seal 240 is inflated and deflated. Note, each grip pad 262 can be secured in a given position along the elastic cord 264 to maintain proper spacing and distribution of the grip pads 262 about the elastic cord 264.

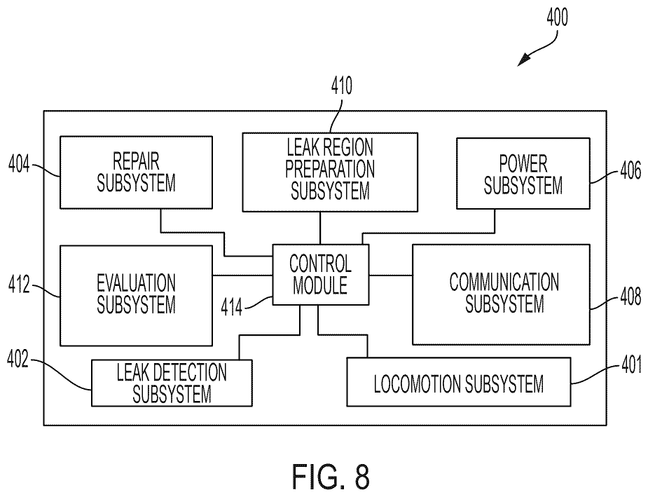

Referring to the block diagram of FIG. 8, repair functions can be performed by various subsystems of one or more pipe repair devices 400 in the pipe repair system 300. Example aspects of a pipe repair device 400 of the disclosed pipe repair system 300 can comprise a locomotion subsystem 401, a leak detection subsystem 402, and a pipe repair subsystem 404, as will be described in further detail below. The pipe repair device 400 can further comprise a power subsystem 406 and a communications subsystem 408. In some aspects, the pipe repair device 400 can also comprise a leak region preparation subsystem 410 and/or a repair evaluation subsystem 412. According to the example aspects, the various subsystems of the pipe repair device 400 can be controlled by a control module 414. Note, alternate aspects of pipe repair devices 400, such as device 403, can perform different repair functions than those noted herein. In some aspects, the pipe repair system 300 can be used in municipal drinking water systems, while other aspects, the pipe repair system 300 can be used in other pipeline systems, such as oil pipelines, gas pipelines, etc.

### Control Module 414

Example aspects of the control module 414 can function to provide control instructions to the various subsystems of the pipe repair device 400. The control module 414 can also function to generate control instructions in response to and/or based on sensor inputs. In example aspects, the control module 414 can be self-contained within the pipe repair device 400 and can comprise a processor (not shown) attached to the pipe repair device 400. In a second aspect, the control module 414 can be implemented at a remote computing system (not shown) and can be connected to the pipe repair device 400 of the pipe repair system 300 by a data link (e.g., a wired tether 109 (shown in FIG. 1), a wireless link, etc.). However, the control module 414 can be otherwise suitably implemented in other aspects.

### Power Subsystem 406

The power subsystem 406 can function to provide power to the various subsystems of the pipe repair device 400 to facilitate operation of the subsystems. In a first aspect, the power subsystem 406 can comprise the tether 109 that can carry electrical power from a surface generator (not shown) to the pipe repair device 400 within the pipeline 310. In a second aspect, the power subsystem 406 can comprise a battery module (not shown) onboard the pipe repair device 400. However, in other aspects, the power subsystem 406 can comprise any suitable energy storing and/or generating components.

### Communications Subsystem 408

The pipe repair device 400 can also comprise the communications subsystem 408 in various aspects. The communications subsystem 408 can function to transmit and to receive control instructions and sensor inputs. In one aspect, the communications subsystem 408 can comprise a serial data bus (not shown) connected to the tether 109 that can directly connect the pipe repair device 400 to a computing system (not shown) outside of the pipeline 310 (e.g., providing a serial data connection). In another example, the communications subsystem 408 can comprise a wireless radio (not shown) that can be connected to the computing system by a wireless data link. In yet another example, the communications subsystem 408 can comprise an acoustic-data transducer (not shown) that can send and receive signals transmitted as vibrations through a wall of the pipeline 310 and/or the water within the pipeline 310. In other aspects, the communications subsystem 408 can comprise any other suitable components for communicating between the pipe repair device 400 and the computing system.

### Locomotion Subsystem 401

As shown in FIG. 1, the pipe repair device 400 can comprise a body 420 that can be, optionally, formed from an NSF/ANSI 61 certified material that can be approved as safe for use in drinking-water applications, such as, for example, stainless steel. In other aspects, the body 420 can be formed from another suitable material, such as, for example, aluminum, other metals, plastic, etc. As best seen in FIG. 1, the tether 109 can be attached to the body 420 such that the tether 109 can trail behind the pipe repair device 400 as it moves in a forward direction through the pipeline 310.

The locomotion subsystem 401 can function to transport the pipe repair device 400 and, therefore, pipe repair system 300, within the pipeline 310 to the region of the leak 312. As shown in FIG. 1, the locomotion subsystem 401 can comprise a transport mechanism for transporting the pipe repair device 400 along an inner surface 311 of the pipeline 310. In a specific example aspect, the transport mechanism can comprise radially-repositionable tracks 422 attached to the body 420 (e.g., multiple tracks 422 positioned equidistant circumferentially about the pipe repair device 400) that can be biased against the inner surface 311 of the pipeline 310.

In one aspect, each of the tracks 422 can be biased against the inner surface 311 of the pipeline 310 by a hydraulic cylinder (not shown). For example, an onboard pump can pump fluid to the hydraulic cylinders, and the fluid can apply pressure to a piston 423 of the hydraulic cylinder. The piston 423 can force the respective track 422 outward against the inner surface 311 of the pipeline 310. According to example aspects, the hydraulic cylinders can allow the pipe repair device 400 to accommodate pipes 314 of varying interior diameters because the tracks 422 can be radially repositionable relative to the body 420. In another aspect, the tracks 422 can be biased against the inner surface 311 of the pipeline 310 by pneumatic cylinders. In such an aspect, compressed air can be used to force the tracks 422 outward against the inner surface 311 of the pipeline 310. In still other aspects, the tracks 422 can be biased against the inner surface 311 of the pipeline 310 by other suitable biasing means, such as, for example, a compression spring or by a controllable scissor-jack mechanism. Moreover, in other aspects, the pipe repair device 400 can comprise alternative or additional mechanisms for rolling, sliding, gliding, or otherwise moving along the inner surface 311 of the pipeline 310, such as, for example, wheels.

### Leak Detection Subsystem 402

Example aspects of the pipe repair device 400 can further comprise the leak detection subsystem 402, which can function to identify the presence of the leak 312 (FIG. 1) and the position of the leak region requiring repair relative to the pipe repair device 400, in order to enable the pipe repair device 400 to suitably position itself relative to the leak region for a repair. In a first aspect, the pipe repair device 400 can comprise an image sensor (e.g., a camera, not shown) for visually identifying the leak region 312. In an example of this aspect, the pipe repair device 400 can stream video data collected via the image sensor to a remote operator in order to manually identify the leak region 312 based on the visibility of damage to the pipeline 310. Some aspects of the pipe repair device 400 can also comprise a lighting mechanism (not shown) for illuminating the interior of the pipeline 310 for improved visibility. Other example aspects of the pipe repair device 400 can comprise additional or alternative technologies for detecting the leak 312 within the pipeline 310. For example, other technologies can include, but are not limited to, ultrasound, magnetic flux, lidar, sonar, laser, spectral aerial imaging, and light/infrared technologies. Another technology for detecting the leak 312 can include inserting dyes or gasses into the pipeline 310 and measuring for seepage through the leak 312.

Upon detection of the leak 312, the locomotion subsystem 401 can transport the pipe repair device 400 within the pipeline 310 to the leak region and, using the leak detection subsystem 402, position the pipe repair device 400 at an ideal location for repairing the leak 312. The locomotion subsystem 401 can transport the pipe repair device 400 to the region of the leak 312 after the leak 312 is identified or can transport the pipe repair device 400 contemporaneously with locating the leak region (e.g., transport the pipe repair device 400 though the pipeline 310 and identify the leak region as the pipe repair device 400 traverses the pipeline 310).

### Leak Region Preparation Subsystem 410

Some example aspects of the pipe repair device 400 can comprise the leak region preparation subsystem 410. The leak region preparation subsystem 410 can comprise a resurfacing mechanism (not shown) that can, in variations, function to grind, to ablate, to scour, and/or otherwise to remove material suitably from the inner surface 311 of the pipe 310 in the region around the leak 312. In additional or alternative aspects, the resurfacing mechanism can overlay additional material on the inner surface 311 (e.g., fill in uneven areas of the inner surface 311 with additional material to prepare a substantially smooth inner surface 311 at the region of the leak 312).

In some aspects, in addition to the linestopping plug assemblies 100, 200 discussed above, the leak region preparation subsystem 410 can comprise a volume control mechanism (not shown) that can function to control a controlled preparation volume of the pipeline 310 proximal the leak 312. Example aspects of the volume control mechanism can isolate the controlled preparation volume. The volume control mechanism can provide a suction force to the controlled preparation volume proximate the leak 312 (e.g., to prevent removed pipe material and/or resurfacing material from being entrained in fluid flowing through the pipeline 310 and carried downstream), a barrier to temporarily block and/or to limit fluid flow passed the barrier (e.g., an inflatable bladder and/or balloon that can be expanded downstream of the leak 312), or any other suitable mechanism for regulating the conditions of the controlled preparation volume proximal the leak 312. Other example aspects of the pipe repair device 300 may not comprise the leak region preparation subsystem 410.

### Pipe Repair Subsystem 404

The pipe repair device 400 can also comprise the pipe repair subsystem 404 for repairing the leak 312 in the pipeline 310 detected by the leak detection subsystem 402 described above. The pipe repair subsystem 404 can function to reduce the leak rate through the leak 312 of the pipeline 310 up to and/or below a leak rate threshold by applying a repair material to the leak 312. Applying the repair material can function to provide an impermeable mechanical barrier between the fluid (e.g., water) within the pipeline 310 and the environment external to the walls of the pipeline 310 in order to repair the leak 312. Example aspects of the repair material can be a NSF/ANSI 61 certified material that can be approved as safe for use in drinking-water applications In a first aspect, the repair material can comprise a liquid-phase repair material.

Specifically, the repair material can be epoxy reagents. The epoxy reagents can be, for example, an acrylic-based mixture, a polyester-based mixture, a resin-based mixture, or any other suitable epoxy mixture. In aspects wherein the repair material is a liquid-phase repair material, the repair material can comprise a binder. The binder can be an organic binder, an inorganic binder, a combination thereof, and/or any suitable binder. In examples, the repair material can comprise a water-insoluble cement, plaster, polymer compound (e.g., epoxy, thermoplastic, foam filler material, resin, etc.), and/or any other suitable material that can be applied to the leak 312 in a liquid or semi-liquid phase. The repair material and/or components thereof can optionally comprise curable compounds (e.g., compounds that solidify upon curing). Such compounds can be curable via heat application, exposure to water, exposure to other compounds (e.g., a reagent that causes a phase-change in the curable compound), exposure to electromagnetic radiation (e.g., ultraviolet light), and/or curable in any other suitable manner.

In another, the pipe repair subsystem 404 can comprise a stent (not shown) for repairing the leak 312 at the leak region. Example aspects of a stent can be expandable and compressible, such that the stent can be oriented in an expanded configuration, and a compressed configuration. The stent can be oriented in the compressed configuration for transport of the stent by the pipe repair device 400 to the leak region. The stent can be compressed by a compression mechanism, such as a compression sleeve (not shown). In other aspects, a tensioning mechanism can be used to orient the stent in the compressed configuration, such as, for example, a cable (not shown) configured to contract the stent radially inwardly. According to example aspects, the stent can be positioned proximate the leak 312 and can be expanded within the pipe 314 by removing a compression force applied by the compression mechanism. In the expanded configuration, the sealing layer of the stent can engage the inner surface 311 of the pipe 314 at the region near the leak 312. The sealing layer can press against the leak 312 to create a watertight seal between the stent and the inner surface 311 of the pipe 314 to repair the leak 312.

In another, the repair material can comprise metal compounds introduced into the leak region to repair the leak 312. For example, repairing the leak 312 can comprise spot-welding the leak 312, and the repair material can comprise pipe material proximal the leak region and/or additional metallic filler material that can be melted into the leak region (e.g., using a submersible welding head) and cooled (e.g., actively cooled, passively cooled) in situ to repair the leak 312.

### Evaluation Subsystem 412

According to example aspects, the pipe repair device 400 can also comprise an evaluation subsystem 412. The evaluation sub-system 412 can function to determine whether the repair successfully met a predetermined repair criteria (e.g., whether the leak 312 was stopped, whether the leak rate was reduced below a threshold leak rate, etc.). In example aspects, the evaluation subsystem 412 can comprise a leak evaluation mechanism comprising a hydrophone (not shown) and a processor. In some example aspects, the processor can be located on or within the pipe repair device 400, while in other aspects, the processor can be located remote from the pipe repair device 400. The hydrophone can extract a frequency power spectrum of noise in the pipe 314 proximal the region near the leak 312, and the processor can identify an audio signature corresponding to the leak 312 and determine a change in the signature (e.g., disappearance of the audio signature, reduction of the audio signature signal power below a threshold signal power) indicative of leak repair and/or satisfaction of the predetermined repair criteria. However, the evaluation subsystem 412 can comprise any suitable components for evaluating the leak repair.

### Methods of Use

Various methods for repairing a pipeline 310 (FIG. 1) with the pipe repair system 300 are disclosed. In an example aspect, a method for repairing the pipeline 310 can comprise the steps of inserting the pipe repair system 300 into a pipeline 310, detecting the leak 312 at a leak region in the pipeline 310, transporting the pipe repair system 300 through the pipeline 310 to the region adjacent the leak 312, and repairing the leak 312. In some aspects, the steps of detecting the leak 312 and transporting the pipe repair system 300 through the pipeline 310 can be performed concurrently. Further, in some aspects, the method can further comprise the step of detecting the leak 312 after the step of preventing fluid flow within the pipeline 310 in the region adjacent the leak 312. Some methods can also comprise the steps of preparing the region adjacent the leak 312 and/or evaluating the repaired leak 312.

In example aspects, the pipe repair system 300 can be inserted into the pipeline 310 at an existing access point, such as, for example, a fire hydrant, a service entrance, or any other suitable point of entry that can allow for routine insertion of the pipe repair system 300 into the pipeline 310. Inserting the pipe repair system 300 into the pipeline 310 at an existing access point and remotely navigating the pipe repair system 300 through the pipeline 310 can eliminate the need to dig up the surrounding terrain to locate and to repair the leak 312, which can save time and costs when performing repairs. As best seen in FIG. 1, some aspects of the present disclosure can include disposing at least one pipe repair device between the two linestopping plug assemblies 100. For example, the pipe repair device(s) 400 disposed in the control volume 315 established between the two linestopping plug assemblies 100 will be used to repair the leak 312.

Once inserted into the pipeline 310, the leak detection subsystem 402 can detect the leak 312 in the pipeline 310 and can pinpoint the location of the leak 312 in the pipeline 310. In a first aspect, the step of detecting the leak 312 can comprise visually identifying the region adjacent the leak 312. Visually identifying the region of the leak 312 can comprise streaming video data collected via an image sensor (i.e., a camera) of the pipe repair device 400 to a remote operator to manually identify the leak region based on the visibility of air bubbles entering the pipeline 310 proximate the leak region or by the visibility of damage to the pipeline 310. In a second aspect, detecting the leak 312 can comprise aurally identifying the leak region. Aurally identifying the leak region can comprise tracking on or more hydrophones (not shown) proximate the inner surface 311 of the pipeline 310 while transporting the pipe repair system 400 (e.g., using a locomotion subsystem 401), and identifying the axial and azimuthal position of the leak 312 based on triangulation of hydrophone-derived audio signatures corresponding to leakage out of the pipeline 310.

Upon detection of the leak 312, the locomotion subsystems 402 of the pipe repair devices 400 can transport the pipe repair system 300 to the leak 312. In one aspect, transporting the pipe repair system 300 through the pipeline 310 can comprise rolling the pipe repair system 300 along the inner surface 311 of the pipeline 310. Rolling along the inner surface 311 of the pipeline 310 can comprise biasing the one or more tracks 422 of the pipe repair devices 400 against the inner surface 311 of the pipeline 310, supplying power to one or more motors of the pipe repair devices 400, and driving the tracks 422 with the motors. In another aspect, transporting the pipe repair system 300 through the pipeline 310 can comprise propelling the pipe repair system 300 through the pipeline 310. Propelling through the pipeline 310 can comprising supplying power to one or more motors of the pipe repair devices 400 and driving a propulsion mechanisms with the motors. In example aspects, the propulsion mechanisms can be an impeller, propeller, and/or any other suitable submersible propulsion mechanism.

In some aspects, a current of the fluid flowing in the pipeline 310 can assist in moving the pipe repair system 300 through the pipeline 310. In other aspects, a water hammer can be introduced into the pipeline 310 to generate a pressure force to assist in moving the pipe repair system 300 through the pipeline 310. As the pipe repair system 300 moves through the pipeline 310, fluid in the pipeline 310 can continue to flow around and/or through the pipe repair system 300. As such, the flow of fluid in the pipeline 310 can continue uninterrupted as the pipe repair system 300 is navigated through the pipeline 310. Such a configuration can minimize the need to shut off the fluid flow during repairs, which can save costs for the service provider and prevent interruption of service to customers.

Repairing the leak 312 can optionally comprise creating a controlled volume 315 surrounding the leak 312, which can function to isolate the controlled volume 315 proximal the leak 312 from the remainder of the internal volume of the pipeline 310. The controlled volume 315 can exhibit a flow rate through the controlled volume 315 that is less than a threshold flow rate (e.g., the background flow rate through the pipeline 310, a predetermined threshold flow rate, etc.), but can alternatively exhibit any suitable flow rate. The controlled volume 315 can comprise a liquid water level (e.g., volume of liquid water) less than a threshold water level (e.g., less than 100% liquid water, less than 50% water, less than 10% water, etc.), but can alternatively comprise any suitable water level. The pressure within the controlled volume 315 can be less than a threshold pressure (e.g., the background pressure within the pipeline 310, a predetermined fraction of the background pressure within the pipeline 310, etc.), but can alternatively be any suitable pressure.

As shown in FIG. 1, creating a controlled volume work space 315 in the region of the leak 312 can optionally comprise transporting the pipe repair system 300 along the interior of the pipeline 310 until the leak 312 is disposed between the upstream linestopping plug assembly 100a and the downstream linestopping plug assembly 100b. After the upstream linestopping plug assembly 100a is disposed in the desired position, the gripper plates 130 of the upstream linestopping plug assembly 100a can be activated to engage the inner surface 311 of the pipeline 310. Force exerted on the front end 104 of the upstream linestopping plug assembly 100a can enhance the locking force exerted on the inner surface 311 of the pipeline 310 by the gripper plates 130 due to their self-locking design. After the gripper plates 130 have engaged the inner surface 311 of the pipeline 310, the bag seal 170 of the upstream linestopping plug assembly 100a can be inflated from a first deflated state to a second inflated state so that the annular ribs 182 thereof can engage the inner surface 311 of the pipeline 310 thereby preventing the flow of fluid in the downstream direction. Next, the remainder of the pipe repair system 300 can be mechanically decoupled from the upstream linestopping plug assembly 100a and transported in the downstream direction until the downstream linestopping plug assembly 100b is disposed in the desired position. Once positioned, the downstream linestopping plug assembly 100b can activate in the same manner discussed above with regard to the upstream linestopping plug assembly 100a. As shown, a retractable tether 109 can physically connect the upstream linestopping plug assembly 100a to the remainder all of the pipe repair system 300 and can extend along the inner surface 311 of the pipeline 310, thereby defining the length of the controlled volume workspace 315. After the upstream and downstream linestopping plug assemblies 100a, 100b have fully engaged the corresponding section of pipeline 310, the controlled volume 315 defined therebetween can be drained. In one aspect, air or other gasses can be forced into the volume of pipeline 310 disposed between the linestopping plug assemblies 100a, 100b to force any fluid disposed in the volume to pass outwardly of the volume through check valves disposed in the linestopping plug assemblies 100a, 100b.

The method can optionally comprise the step of preparing the region adjacent the leak 312 before repairing the leak 312. In one aspect, the step of preparing the leak region can comprise preparing the inner surface 311 of the pipeline 310 by removing material proximate the leak 312. For example, a resurfacing mechanism can reduce the surface roughness to produce a suitable (e.g., substantially smooth) surface at which to repair the leak 312. Preparing the inner surface 311 can comprise grinding, abrading, or otherwise mechanically preparing the inner surface 311, compressing the inner surface 311, chemically reacting the inner surface 311, or otherwise preparing the inner surface 311.

Upon preparing the region adjacent the leak 312, the leak 312 can be repaired.

The step of repairing the leak 312 can comprise applying a repair material to the leak 312 using a repair mechanism of the repair subsystem 404. In one aspect, the repair material can be a liquid-phase repair material, and applying the repair material can comprise, for example, suffusing the leak 312 with an epoxy compound. In another aspect, the repair material can be a solid material, and applying the repair material can comprise, for example, affixing a patch to the leak 312.

Optionally, the repair material can comprise curable compounds. Thus, repairing the leak 312 can optionally comprise curing the curable compounds included in the repair material, such as by exposing the curable compounds to heat (e.g., heating the curable compounds using a heater of the repair subsystem 404), exposing the curable compounds to water (e.g., by introducing water into the controlled volume 315 proximal the leak 312 and into which repair material has been applied), exposing the curable compounds to electromagnetic radiation (e.g., by shining ultraviolet light onto the region adjacent the leak 312 at which repair material has been applied, using a light emitter of the repair subsystem 404), and/or by any other suitable mechanism or technique.

In one specific example aspect, repairing the leak 312 can comprise providing a stent (not shown) in a compressed configuration, the stent comprising a spring and a sealing layer, reconfiguring the stent from the compressed configuration to an expanded configuration, and pressing the sealing layer of the stent against the inner surface 311 of the pipeline 310 at the leak region to create a water-tight seal between the sealing layer and the region adjacent the leak 312. Another example aspect of repairing the leak 312 can comprise spot-welding the leak 312. Spot-welding the leak 312 can comprise melting pipe material proximate the leak 312 and/or additional metallic filler material into the leak 312 (e.g., using a submersible welding head) and cooling the material (e.g., actively cooled, passively cooled) in situ to repair the leak 312.

Another specific example aspect of repairing the leak 312 can comprise providing an epoxy applicator that can comprise a flexible tube (not shown) attached to a linear actuator, actuating the epoxy applicator proximal to the leak 312, wherein an outlet of the flexible tube can be arranged adjacent to the leak 312, forcing a quantity of epoxy through the tube to create an epoxy bead that covers the leak 312, pausing for a predetermined time period (e.g., 10 seconds, 10 minutes, 1 hour, etc.) for the epoxy to transition to a solid state (e.g., a cured state), and mechanically separating the solidified epoxy bead from the tube (e.g., using a guillotine of the repair subsystem 404 such as a single bladed guillotine, a double bladed guillotine, etc.). In some aspects, as described above, the tube can be a mixing nozzle.

Example aspects of the method can also comprise the step of evaluating the repair. Evaluating the repair can be performed by the evaluation subsystem 412. A first aspect of evaluating the repair can comprise visually evaluating the repair. Visually evaluating the repair can comprise collecting imagery data at an image sensor of the pipe repair system 300 and transmitting the imagery data to a remote operator (e.g., wherein the remote operator views the imagery data rendered on a display outside the pipe) that can manually evaluate that the leak rate has been reduced below a threshold level. A second aspect of evaluating the repair can comprise sonically evaluating the repair. Sonically evaluating the repair can comprise collecting auditory data at a hydrophone (not shown) of the pipe repair system 300, extracting auditory signatures from the auditory data, and determining that the auditory signatures are indicative of a reduced fluid leakage rate (e.g., reduced below a threshold leakage rate, reduced by a predetermined ratio relative to an initial leakage rate, etc.).

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A linestopping plug assembly for securing flow of a fluid within a pipe, comprising:
a body portion having a front body portion, a rear body portion, and a longitudinal center axis extending therebetween; and
an inflatable bag seal that is coupled to the body portion and comprises a cylindrical side wall,
wherein the inflatable bag seal is inflatable between a first deflated state and a second inflated state, the cylindrical side wall moving radially outwardly with respect to the longitudinal center axis as the inflatable bag seal is inflated from the first deflated state to the second inflated state.

2. The linestopping plug assembly of claim 1, wherein when the inflatable bag seal is in the first deflated state a flow volume is defined between the cylindrical side wall of the inflatable bag seal and an inner surface of the pipe, and when the inflatable bag seal is in the second inflated state the cylindrical side wall of the inflatable bag seal is in contact with the inner surface of the pipe about a full circumference of the cylindrical side wall of the inflatable bag seal.

3. The linestopping plug assembly of claim 2, wherein the body portion further comprises a throughbore that is in fluid communication with the inflatable bag seal.

4. The linestopping plug assembly of claim 2, further comprising a gripper assembly that comprises at least one tooth that is configured to selectively engage an inner surface of the pipe, wherein the gripper assembly is movable from a first radially-inward position to a second radially-outward position in which the at least one tooth contacts the inner surface of the pipe.

5. The linestopping plug assembly of claim 4, the gripper assembly further comprising a pair of gripper plates, each gripper plate being pivotally secured to the rear body portion, wherein the inflatable bag seal is affixed to the front body portion.

6. The linestopping plug assembly of claim 5, wherein each gripper plate is pivotably secured to the rear body portion by at least one linkage.

7. The linestopping plug assembly of claim 4, wherein the gripper assembly comprises at least one annular grip ring disposed on an outer surface of the cylindrical side wall of the inflatable bag seal.

8. The linestopping plug assembly of claim 7, wherein the gripper assembly further comprises a pair of annular grip rings, each annular grip ring comprising a plurality of grip pads that are secured together by an annular band.

9. The linestopping plug assembly of claim 8, wherein the cylindrical side wall of the inflatable bag seal extends the entire length of a cylindrical side wall of the body portion of the linestopping plug assembly.

10. A pipe repair system for repairing a leak in a pipe, comprising:
at least one linestopping plug assembly, each linestopping plug assembly comprising:
a body portion having a front body portion, a rear body portion, and a longitudinal center axis extending therebetween; and
an inflatable bag seal that is affixed to the body portion and comprises a cylindrical side wall,
wherein the inflatable bag seal is inflatable between a first deflated state and a second inflated state, the cylindrical side wall moving radially outwardly with respect to the longitudinal center axis as the inflatable bag seal is inflated from the first deflated state to the second inflated state; and
a pipe repair device comprising:
a body;
a sensor attached to the body, the sensor being configured for detecting the leak in the pipe;
a transport mechanism attached to the body for transporting the pipe repair device along the pipe; and
a repair mechanism comprising a repair material for repairing the leak.

11. The pipe repair system of claim 10, wherein the at least one linestopping plug assembly further comprises a first linestopping plug assembly and a second linestopping plug assembly, the pipe repair device is disposed between the first linestopping plug assembly and the second linestopping plug assembly, and when the inflatable bag seal is in the first deflated state a flow volume is defined between the cylindrical side wall of the inflatable bag seal and an inner surface of the pipe, and when the inflatable bag seal is in the second inflated state the cylindrical side wall of the inflatable bag seal is in contact with the inner surface of the pipe about a full circumference of the cylindrical side wall of the inflatable bag seal.

12. The pipe repair system of claim 11, further comprising a gripper assembly that comprises at least one tooth that is configured to selectively engage an inner surface of the pipe, wherein the gripper assembly is movable from a first radially inward position to a second radially-outward position in which the at least one tooth contacts the inner surface of the pipe.

13. The pipe repair system of claim 12, the gripper assembly further comprising a pair of gripper plates, each gripper plate being pivotally secured to the rear body portion, wherein the inflatable bag seal is affixed to the front body portion.

14. The pipe repair system of claim 11, wherein the gripper assembly comprises at least one annular grip ring disposed on an outer surface of the cylindrical side wall of the inflatable bag seal.

15. The pipe repair system of claim 14, wherein the gripper assembly further comprises a pair of annular grip rings, each annular grip ring comprising a plurality of grip pads that are secured together by an annular band.

16. A method for repairing a pipeline, comprising the steps of:
obtaining a pipe repair system comprising a pipe repair device and at least one linestopping plug assembly having an inflatable bag seal;
inserting the pipe repair system into the pipeline;
detecting a leak at a leak region of the pipeline; and
preventing fluid flow within the pipeline by inflating the inflatable bag seal.

17. The method of claim 16, further comprising the step of:
repairing the leak in the pipeline; wherein
the step of obtaining the pipe repair system further comprises providing a first linestopping plug assembly and a second linestopping plug assembly; and
the step of inserting the pipe repair system into the pipeline further comprises disposing the pipe repair device between the first linestopping plug assembly and the second linestopping plug assembly.

18. The method of claim 17, wherein the step of preventing fluid flow within the pipeline further comprises inflating the bag seal of the first linestopping plug assembly and subsequently inflating the bag seal of the second linestopping plug assembly.

19. The method of claim 18, wherein the step of inserting the pipe repair system into the pipeline further comprises inserting the first linestopping plug assembly into the pipeline so that the first linestopping plug assembly is disposed upstream of the second linestopping plug assembly in the pipeline.

20. The method of claim 18, further comprising the step of draining the fluid from a volume within the pipeline that is disposed between the first linestopping plug assembly and the second linestopping plug assembly.
